(19) United States
(12) Patent Application Publication
(10) Pub. No.: US 2023/0374971 A1
(43) Pub. Date: Nov. 23, 2023

(54) A MECHANISM FOR RESTRAINING MOVEMENT OF A LOCKING PIN

(71) Applicant: LM WIND POWER A/S, Kolding (DK)

(72) Inventors: Scott HUTH, New Orleans, LA (US); Jon Stuart WRIGHT, New Orleans, LA (US); Graham ALDINGER, New Orleans, LA (US); Rohit AGARWAL, New Orleans, LA (US)

(21) Appl. No.: 18/039,014

(22) PCT Filed: Nov. 26, 2021
(86) PCT No.: PCT/EP2021/083194

§ 371 Date: May 26, 2023

(30) Foreign Application Priority Data
Nov. 27, 2020 (GB) 2018692.0

(51) Int. Cl. F03D 1/06

(52) U.S. Cl. CPC F03D 1/0675; F05B 2260/31; F05B 2230/604

(57) ABSTRACT

A mechanism for restraining movement of a locking pin is disclosed. The mechanism includes a plurality of bushings 1. At least one of the plurality of bushings is provided in an aperture 76, 78 and on either ends of the locking pin 74. Further, at least one primary restraining mechanism 7 is configured in the at least one bushing 1 at one end of the locking pin 74, where the primary restraining mechanism 7 is fixedly connected to the at least one bushing 1 and is configured to restrain at least one of sliding and rotary movement of the locking pin 74.

### FIELD OF THE INVENTION

The present invention relates in general to a wind turbine. Particularly to a locking pin in a spar structure of the blade for connecting a first blade segment and a second blade segment of the wind turbine blade. Further embodiments the present invention relates to a mechanism for restraining the movement of the locking pin in the spar structure.

### BACKGROUND OF THE INVENTION

Wind power is one of the fastest-growing renewable energy technologies and provides a clean and environmentally friendly source of energy. Typically, wind turbines comprise a tower, generator, gearbox, nacelle, and one or more rotor blades. The kinetic energy of wind is captured using known air foil principles. Modern wind turbines may have rotor blades that exceed 90 meters in length.

Wind turbine blades are usually manufactured by forming a shell body from two shell parts or shell halves comprising layers of woven fabric or fibre and resin. Spar caps or main laminates are placed or integrated in the shell halves and may be combined with shear webs or spar beams to form structural support members. Spar caps or main laminates may be joined to, or integrated within, the inside of the suction and pressure halves of the shell.

As the size of wind turbines increases, the manufacturing and transporting of wind turbine blades becomes more challenging and costly. As a solution to this problem wind turbine blades can be provided in two or more segments. This can result in an easier manufacturing process and may reduce the cost of transportation and erection of wind turbines. The respective blade segments may be transported to the erection site individually, where they can be assembled to form the wind turbine blade.

However, several challenges are associated with such segmented design. These often relate to the manufacturing and joining of the shell segments including load bearing structures such as spar beams, shear webs or other internal components. For instance, the wind turbine blade may comprise of a first segment and a second segment. These segments of the wind turbine blade are usually joined together by a spar structure. The spar structure may include a first part connected to the first blade segment and a second part connected to the second blade segment. The first and the second parts are defined with apertures and a locking pin is usually provided inside the apertures for connecting the first and the second parts of the spar structure. Thus, the first and the second segments of the wind turbine blade are also connected together.

The locking pin which connects the first and the second parts in the spar structure is often subjected to multiple forces when the blades of the wind turbine are in operational condition. These forces may impart a sliding or rotary movement to the locking pin. This movement of the locking pin is often not desirable since the constant sliding and rotation of the pin along the inner surfaces of the aperture may cause the surface of the pin to wear out. Further, the operational life of the locking pin may also considerably reduce since the abrasion along the surface of the locking pin may induce cracks along the locking pin. These cracks may further propagate through the locking pin as the locking pin is subjected to multiple forces during the rotation of the blade and the locking pin may eventually shatter. Consequently, the link between the first and the second segment may be significantly damaged. Hence, there exists a need to improve the reliability of the link between the first and the second blade segments.

Further, the locking pin is housed inside the aperture of the spar structure by a plurality of bushings. The bushings are provided between the locking pin and the aperture. Conventionally, several bushings are provided between the aperture and the locking pin, due to which the assembly of the locking pin inside the aperture would become complex. Further, these bushings are often configured with flanges for support around the locking pin. However, using multiple bushings with flanges only adds to the complexity in configuring the locking pin inside the aperture.

It is therefore an object of the present invention to provide a wind turbine blade with an improved locking pin arrangement.

### SUMMARY OF THE INVENTION

In a non-limiting embodiment of the disclosure, a mechanism for restraining movement of a locking pin is disclosed. The mechanism is provided with a plurality of bushings where, at least one of the plurality of bushings is provided in an aperture and on either ends of the locking pin. Further, at least one primary restraining mechanism is configured in the at least one bushing at one end of the locking pin, where the primary restraining mechanism is fixedly connected to the at least one bushing. Also, the primary restraining mechanism is configured to restrain at least one of sliding and rotary movement of the locking pin.

In an embodiment, a secondary restraining mechanism which is configured to be accommodated in a cavity defined in the locking pin is provided. The secondary restraining mechanism is removably coupled to the locking pin through at least one of the plurality of bushing and restrains the rotary movement of the locking pin.

In an embodiment, the primary restraining mechanism is at least one of a retention cap and a threaded joint.

In an embodiment, the secondary restraining mechanism is at least one of an anti-rotational pin and a retention ring.

In an embodiment, the retention cap is connected to at least one of the bushings and the locking pin by at least one of a first threading connection and a retention pin.

In an embodiment, the at least one bushing provided in the aperture extends along the length of the aperture.

In an embodiment, the at least one bushing provided on either ends of the aperture is defined in the spar structure.

In an embodiment, the at least one of the plurality of bushings provided at a top end of the locking pin and a bottom end of the locking pin are connectable to the locking pin by second threading connection.

In an embodiment, the retention cap is threadingly coupled to the at least one bushing through a retention pin.

In an embodiment, a retaining ring is mounted over the retention cap and the retaining ring is configured to receive and hold the locking pin.

In an embodiment, the cavity is defined with internal threads or a keyway to receive the anti-rotational pin and the anti-rotational pin is at least one of a splined pin or a threaded pin.

In another non-limiting embodiment of the disclosure, a wind turbine blade having a profiled contour is disclosed. The wind turbine blade includes a leading edge and a trailing edge with a chord having a chord length extending therebetween. Further, the wind turbine blade extends in a spanwise direction between a root end and a tip end, where the blade includes a first blade segment connected to a second blade segment by a spar structure. Also, the spar structure includes a first part housed in the first blade segment and a second part housed in the second blade segment. The first part of the spar structure is defined by a first aperture and the second part of the spar structure is defined by a second aperture. Further, a locking pin is provided in the aperture for connecting the first part and the second part of the spar structure and thereby connecting the first blade segment to the second blade segment. The locking pin also includes a mechanism for restraining the movement of the locking pin. The mechanism is provided with a plurality of bushings where, at least one of the plurality of bushings is provided in each of an aperture defined in the spar structure and on either ends of the locking pin. Further, at least one primary restraining mechanism is configured in the at least one bushing provided at one end of the locking pin, where the primary restraining mechanism is fixedly connected to at least one of the bushing. Also, the primary restraining mechanism and is configured to restrain at least one of sliding and rotary movement of the locking pin.

In yet another non-limiting embodiment of the disclosure, a method of assembling a wind turbine blade having a profiled contour including a leading edge and a trailing edge with a chord having a chord length extending therebetween is disclosed. The wind turbine blade extends in a spanwise direction between a root end and a tip end. The method includes steps of connecting a first blade segment with a second blade segment by a spar structure, where the spar structure is provided with a first part housed in the first blade segment and a second part housed in the second blade segment. Further, a first aperture defined in the first part is aligned with a second aperture defined in the second part. Further, a locking pin is inserted in the first aperture and the second aperture of the first part and the second part. Thus, the first blade segment is connected with the second blade segment of the wind turbine blade. A plurality of bushings are provided in the first and the second aperture of the spar structure for housing the locking pin. Also, at least one primary restraining mechanism is configured in the at least one bushing at one end of the locking pin, where the primary restraining mechanism is fixedly connected to the at least one bushing. Also, the primary restraining mechanism is configured to restrain at least one of sliding and rotary movement of the locking pin. Further, a secondary restraining mechanism is configured to be accommodated in a cavity defined in the locking pin. The secondary restraining mechanism is removably coupled to the locking pin through at least one of the plurality of bushing and restrains the rotary movement of the locking pin.

As used herein, the term “spanwise” is used to describe the orientation of a measurement or element along the blade from its root end to its tip end. In some embodiments, spanwise is the direction along the longitudinal axis and longitudinal extent of the wind turbine blade.

### DESCRIPTION OF THE INVENTION

The invention is explained in detail below with reference to an embodiment shown in the drawings, in which

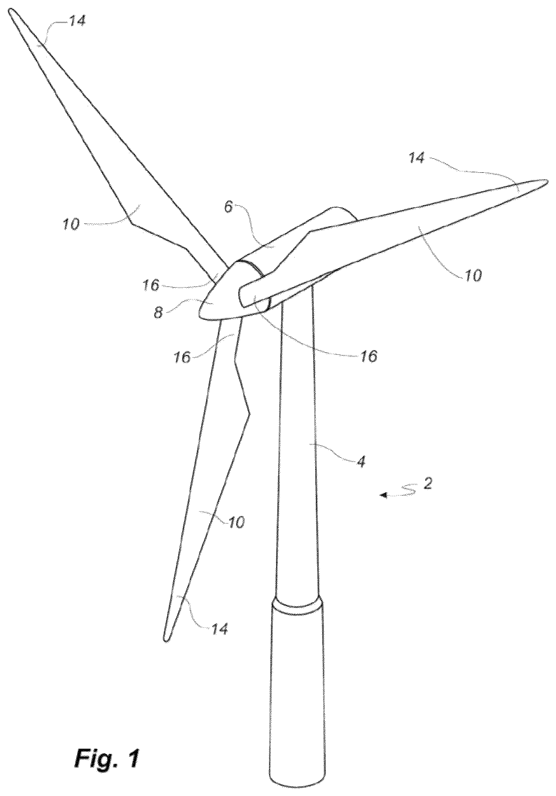

FIG. 1 shows a wind turbine,

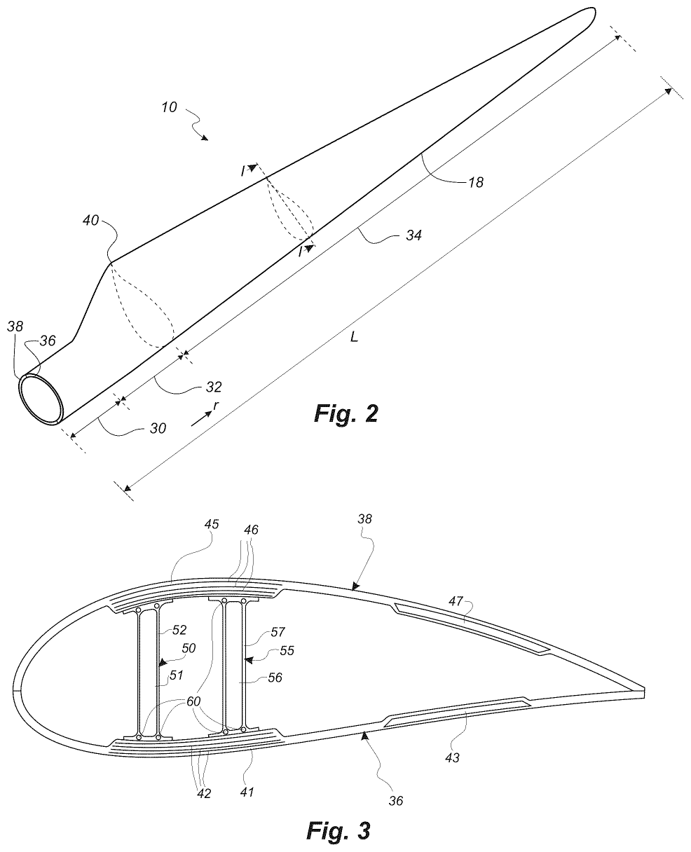

FIG. 2 shows a schematic view of a wind turbine blade,

FIG. 3 shows a schematic view of a cross-section of a wind turbine blade,

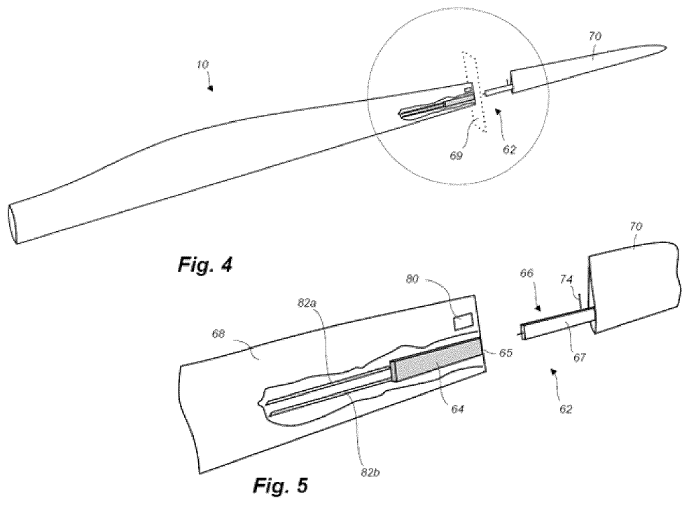

FIG. 4 is a schematic exploded view of a wind turbine blade,

FIG. 5 is an enlarged view of the encircled section in FIG. 4,

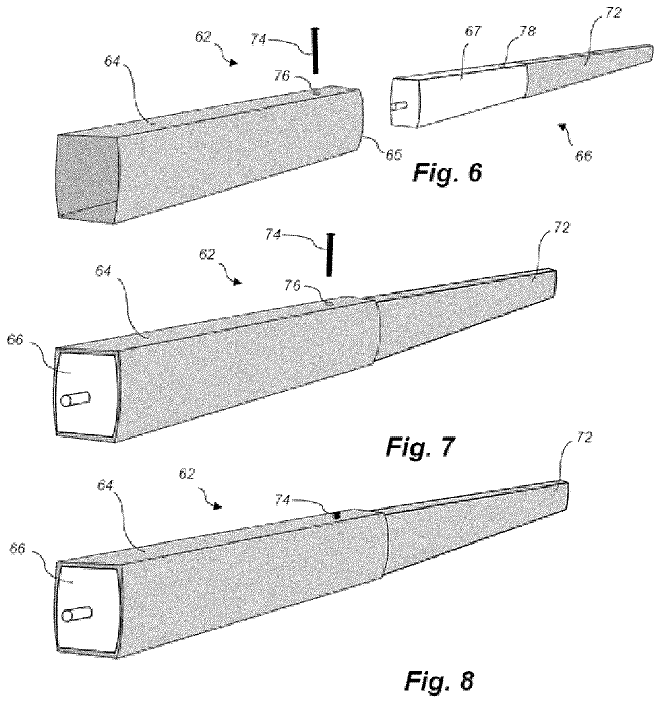

FIGS. 6, 7 and 8 are perspective views of a spar structure of the wind turbine blade,

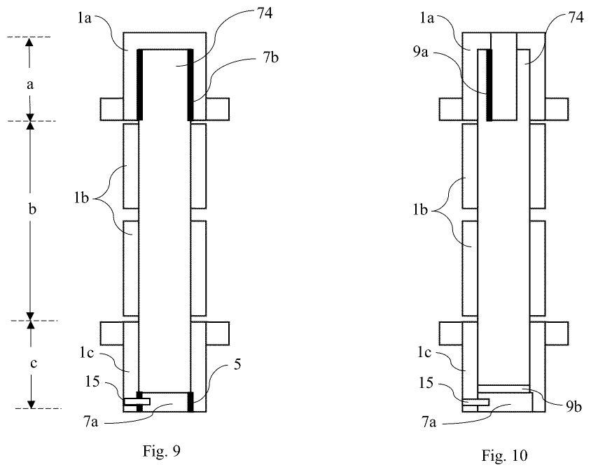

FIGS. 9, 10, 11, 12 and 13 show schematic views of the locking pin according to the present invention, wherein different embodiments of the mechanism for restraining the movement of the locking pin are shown,

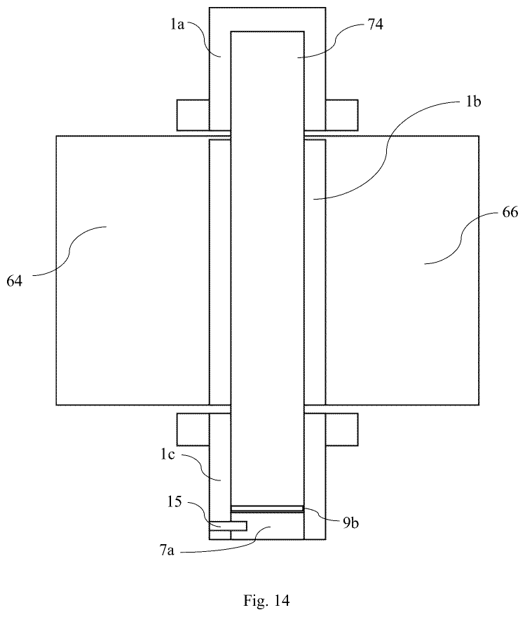

FIG. 14 shows schematic view of the locking pin, wherein the single bushing around the locking pin is shown according to the present invention.

### DETAILED DESCRIPTION

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub 8. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub 8. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34. FIG. 2 also illustrates the longitudinal extent L, length or longitudinal axis of the blade.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part 36 and a suction side shell part 38 that are glued to each other along bond lines at the leading edge 18 and the trailing edge of the blade 20.

FIG. 3 shows a schematic view of a cross section of the blade along the line I-I shown in FIG. 2. As previously mentioned, the blade 10 comprises a pressure side shell part 36 and a suction side shell part 38. The pressure side shell part 36 comprises a spar cap 41, also called a main laminate, which constitutes a load bearing part of the pressure side shell part 36. The spar cap 41 comprises a plurality of fibre layers 42 mainly comprising unidirectional fibres aligned along the longitudinal direction of the blade 10 in order to provide stiffness to the blade. The suction side shell part 38 also comprises a spar cap 45 comprising a plurality of fibre layers 46. The pressure side shell part 38 may also comprise a sandwich core material 43 typically made of balsawood or foamed polymer and sandwiched between a number of fibre-reinforced skin layers. The sandwich core material 43 is used to provide stiffness to the shell in order to ensure that the shell substantially maintains its aerodynamic profile during rotation of the blade. Similarly, the suction side shell part 38 may also comprise a sandwich core material 47.

The spar cap 41 of the pressure side shell part 36 and the spar cap 45 of the suction side shell part 38 are connected via a first shear web 50 and a second shear web 55. The shear webs 50, 55 are in the shown embodiment shaped as substantially I-shaped webs. The first shear web 50 comprises a shear web body and two web foot flanges. The shear web body comprises a sandwich core material 51, such as balsawood or foamed polymer, covered by a number of skin layers 52 made of a number of fibre layers. The blade shells 36, 38 may comprise further fibre-reinforcement at the leading edge and the trailing edge. Typically, the shell parts 36, 38 are bonded to each other via glue flanges.

FIG. 4 is a schematic cut-open, exploded view of a wind turbine and FIG. 5 is an enlarged view of the encircled section in FIG. 4. A pressure side shell half and a suction side shell half are typically manufactured over the entire length L of the wind turbine blade 10. A spar structure 62 is arranged within the shell. The spar structure 62 comprising a first part 64 and a second part 66 [as shown in FIG. 5], the first and second part being releasably coupled to each other, as shown in FIG. 8. The first part 64 of the spar structure 62 is fixed to one or both of the shell halves within the first blade segment 68 and the second part 66 of the spar structure is fixed to one or both of the shell halves within the second blade segment 70.

The shell halves are then closed and joined, such as glued together for obtaining a closed shell, which is subsequently cut along a cutting plane 69 substantially normal to the spanwise direction or longitudinal extent of the blade to obtain a first blade segment 68 and a second blade segment 70. The cutting plane 69 coincides with an end surface 65 of the first part 64 of the spar structure.

As seen in FIGS. 4 and 5, the spar structure 62 extends across the cutting plane 69. As best seen in FIG. 5, the first part 64 of the spar structure 62, which takes the form of a box-shaped sheath member for at least partly enclosing the second part 66 of the spar structure in the illustrated embodiment, is fixed to the first blade segment 68. The second part 66 of the spar structure 62, which comprises a spar box in the illustrated embodiment, is fixed to the second blade segment 70, wherein the second part 66 extends beyond the second blade segment 70 into the first blade segment 68, when the blade segments are assembled.

FIG. 5 illustrates an access opening 80 within the upper half of the illustrated shell for accessing the spar structure and coupling and uncoupling the first and second part of the spar structure 62. For uncoupling, a locking pin 74, as illustrated in FIGS. 6-8, is withdrawn from the aligned respective apertures 76, 78 in each of the first and second part of the spar structure via the access opening 80. Prior to, or after, joining and sealing the first blade segment 68 to the second blade segment 70 for obtaining the wind turbine blade, the first and second part of the spar structure are re-coupled, via the access opening 80, as illustrated in FIG. 8, by re-inserting the locking pin 74 into the aligned respective apertures 76, 78 in each of the first and second part of the spar structure.

FIGS. 6, 7 and 8 illustrate an embodiment of the spar structure 62 with the first part 64 in the form of a conductive, box-shaped sheath member. The spar structure 62 comprises a locking pin 74 for releasably coupling the first part 64 to the second part 66 of the spar structure through aligned respective locking apertures 76, 78 in each of the first and second part of the spar structure 62.

The locking pin 74 provided in the apertures 76 and 78 is explained with greater detail below. FIG. 9 shows the locking pin 74 with multiple bushings 1 and a primary restraining mechanism 7. The multiple bushings may be provided between the inner surface of the apertures 76, 78 and the outer surface of the locking pin 74. The locking pin 74 may be defined by a top end (a), a bottom end (c) and a centeral region (b). The top end (a) and the bottom end (c) of the locking pin 74 may be provided with a first bushing 1a and a third bushing 1c respectively. The first bushing 1a and the third bushing 1c may be defined with flanges. Further, the centeral region (b) of the locking pin 74 may include multiple second bushes 1b. The second bushes 1b may extend throughout the length of the first part 64 and the second part 66. The FIG. 9 depicts the use of two second bushes 1b, however, any number of bushes may be provided along the central region (b) of the locking pin 74. Further, the first bush 1a at the top end (a) of the locking pin 74 may be configured to cover the top surface of the locking pin 74 and the third bush 1c may be defined by a through hole for receiving the locking pin 74.

The locking pin 74 may further be configured with a primary restraining mechanism 7. The primary restraining mechanism 7 may include a retention cap 7a. The retention cap 7a may be provided at the bottom end (c) of the locking pin 74 and the retention cap 7a may be configured to cover and hold the bottom surface of the locking pin 74. Further, the external surface of the retention cap 7a and the internal surface of the third bush 1c may be defined by a first threading connection 5. The retention cap 7a may be fixedly connected to the third bush 1c by the first threading connection 5. The retention cap 7a may also be fixedly connected to the third bush 1c by a retention pin 15. The retention cap 7a may be defined with a cavity that partially extends horizontally into the retention cap 7a and a hole which also extends horizontally along the third bush 1c may be defined near the bottom end of the third bush 1c such that the hole defined in the third bush 1c is aligned with the cavity defined in the retention cap 7a. Further, the retention pin 15 may be inserted into the cavity defined in the retention cap 7a, through the hole defined in the third bush 1c such that the retention pin 15 fixedly connects the retention cap 7a to the third bush 1c. The retention cap 7a serves the purpose of restraining the sliding movement of the locking pin 74. Since the retention cap 7a is fixedly attached to the bottom end of the third bush 1c, the locking pin 74 is restrained from moving downwards and thereby the sliding action of the locking pin is prevented. The locking pin 74 may be subjected to multiple forces during the rotation of the wind turbine blade 10. However, these forces do not trigger the independent sliding and rotary action of the locking pin 74 due to the constraint provided by the retention cap 7a. The locking pin 74 may move along with bushing 1, but the independent movement of the locking pin 74 is completely restrained by the retention cap 7a, and consequently the wear on the surface of the locking pin 74 is also prevented.

The primary restraining mechanism 7 may also comprise of a second threading connection 7b. The internal surface of the first bush 1a and the external surface of the locking pin 74 at the top end (a) may be defined with threads. The first bush 1a may be fixedly connected to the top end (a) of the locking pin 74 by the threads defined on the first bush 1a and the locking pin 74. In an embodiment, once the first bush 1a is fixedly attached to the top end (a) of the locking pin 74 by the second threading connection 7b, the sliding movement and the rotary movement of the locking pin 74 is restrained. The second threading connection 7b, restrains the sliding movement of the locking pin 74 and since the locking pin 74 is threadingly connected to the first bush 1a, the rotary movement of the locking pin 74 is also restrained. Thus, the second threading connection 7b, not only restrains the sliding action of the locking pin 74, but also restrains the rotation of the locking pin 74.

FIG. 10 shows the locking pin 74 configured with a primary restraining mechanism 7 and a secondary restraining mechanism 9. The present embodiment may also include a retention cap 7a as mentioned in the above embodiment. The configuration, orientation and the function of the retention cap 7a is same as mentioned in the above embodiment. Further, the retention cap 7a in the current embodiment may be fixedly connected to the bushing by the retention pin 15 without the first threading connection. As mentioned above, the retention cap restrains the sliding movement and rotational movement of the locking pin 74.

The locking pin 74 as shown in the FIG. 10 also includes a secondary restraining mechanism 9. The secondary restraining mechanism 9 may include a retention pin 9b or a threaded pin 9a. The retention pin 9b may be provided in the third bush 1c and the retention pin 9b may be housed on top of the retention cap 7a. The retention pin 9b is sandwiched between the retention cap 7a and the locking pin 74. Further, the retention pin 9b comes in direct contact with the bottom surface of the locking pin 74 and the retention pin 9b restrains the rotary movement of the locking pin 74. The secondary restraining mechanism 9 also includes the threaded pin 9a. The threaded pin 9a may be housed at the top end (a) of the locking pin 74. The top surface of the first bush 1a may be defined with a through hole and a cavity may be defined at the top end (a) of the locking pin 74. The cavity defined in the locking pin 74 may extend till the length of the first bush 1a. Further, the internal surface of the cavity defined in the locking pin 74, may be defined with threads and the external surface of the threaded pin 9a may be defined with threads. The locking pin 74 and the first bush 1a may thus be fixedly connected by the threaded pin 9a. The threaded pin 9a may extend into the cavity defined in the locking pin 74 and the threaded pin 9a may also extend through the first bush 1a, thereby connecting the first bush 1a and the locking pin 74. The threaded pin 9a restrains the rotary movement of the locking pin 74, since the threaded pin 9a fixedly connects the locking pin 74 to the first bush 1a.

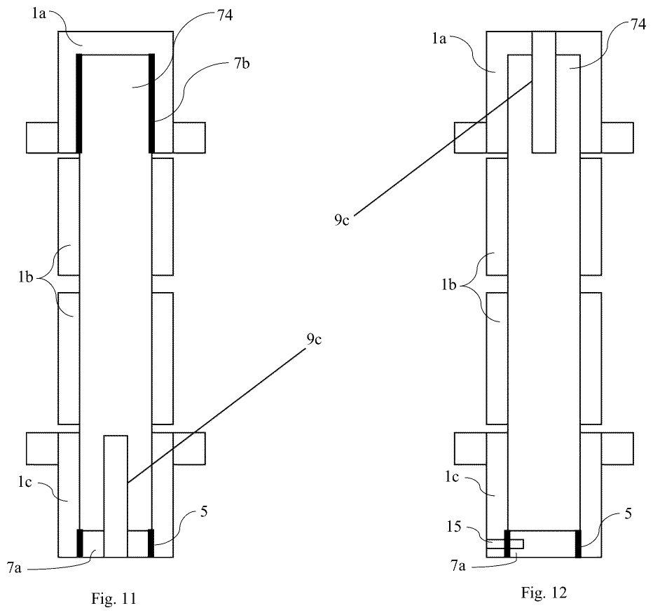

FIGS. 11 and 12 also show other embodiments of the locking pin 74 configured with a primary restraining mechanism 7 and a secondary restraining mechanism 9. With reference to FIG. 11, the locking pin 74 is configured with bushings 1 as mentioned in the above mentioned embodiments. Further, the locking pin 74 is also provided with a retention cap 7a. Similar to the above mentioned embodiments, the retention cap 7a may be provided at the bottom end (c) of the locking pin 74 and the retention cap 7a may be configured to cover the bottom surface of the locking pin 74. Further, the external surface of the retention cap 7a and the internal surface of the third bush 1c may be defined by the first threading connection 5. The retention cap 7a may be fixedly connected to the third bush 1c by the first threading connection 5. The retention cap 7a restrains the sliding movement of the locking pin 74. Further, the retention cap 7a in the current embodiment may not include the retention pin 15. The retention cap 7a may be fixedly connected to the third bush 1c by only the first threading connection 5. Further, the primary restraining mechanism 7 may also include the second threading connection 7b as explained in the above embodiments. The second threading connection 7b restrains the rotary and the sliding movement of the locking pin 74

The secondary restraining mechanism 9 may also include a splined pin 9c. The splined pin 9c may be housed at the bottom end (c) of the locking pin 74. The retention cap 7a may be defined with a through hole and a cavity may be defined at the bottom end (c) of the locking pin 74. The cavity defined in the locking pin 74 may extend till the length of the third bush 1c. Further, the hole defined in the retention cap 7a and the cavity defined at the bottom end (c) of the locking pin 74 may be aligned with each other to house the splined pin 9c. The locking pin 74 and the third bush 1c may thus be fixedly connected by the splined pin 9c and the retention cap 7a. The splined pin 9c may extend into the cavity defined in the locking pin 74 and the splined pin 9c may also extend through the retention cap 7a, thereby connecting the third bush 1c and the locking pin 74 through the retention cap 7a. The splined pin 9c restrains the rotary movement of the locking pin 74, since the splined pin 9c fixedly connects the locking pin 74 to the third bush 1c.

With reference to the FIG. 12, the primary restraining mechanism 7 may include a retention cap 7a with a retention pin 15 and first threading connection 5 as described in the above embodiments. The retention cap restrains the sliding movement of the locking pin 74. Further, the secondary mechanism 9 in the current embodiment may include a splined pin 9c configured at the top end (a) of the locking pin 74.

The top surface of the first bush 1a may be defined with a through hole and a cavity may be defined at the top end (1) of the locking pin 74. The cavity defined in the locking pin 74 may extend till the length of the first bush 1a. The locking pin 74 and the first bush 1a may be fixedly connected by inserting the splined pin 9c inside the cavity of the locking pin 74. The splined pin 9c may extend into the cavity defined in the locking pin 74 and the splined pin 9c may also extend through the first bush 1a, thereby connecting the first bush 1a and the locking pin 74. The splined pin 9c restrains the rotary movement of the locking pin 74, since the splined pin 9c fixedly connects the locking pin 74 to the first bush 1a.

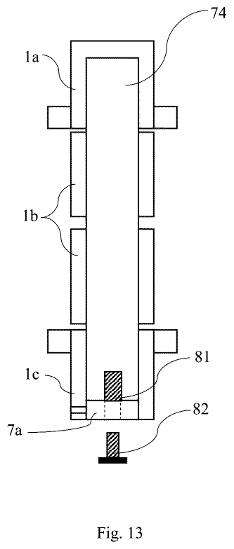

Further, FIG. 13 shows an embodiment of the locking pin 74 configured with a threaded cavity 81 and a fastener 82. The internal surface of the cavity 81 and the external surface of the fastener 82 may be threaded. The threaded cavity 81 may be defined at the bottom end of the locking pin 74 and may be configured to receive the fastener 82. The threaded cavity 81 may extend in the vertical direction or along the length of the locking pin 74. Further, the retention cap 7a may be defined with a through hole at a substantially central portion of the retention cap 7a. The fastener 82 may pass through the hole in the retention cap 7a and the external threads of the fastener 82 may engage with the internal threads of the threaded cavity 81. Consequently, the fastener 82 may fixedly connect the retention cap 7a and the locking pin 74. The threaded cavity 81 and the fastener 82 may thus restrict the sliding and the rotary movement of the locking pin 74.

FIG. 14 show schematic view of the locking pin 74, wherein the second bush 1b around the locking pin 74 is a single member. The first bush 1a and the third bush 1c may be configured as mentioned in the above embodiments. Further, the retention cap 7a with the retention pin 15 and the retention ring 9b may be configured as mentioned in the above embodiments. The second bush 1b provided around the locking pin 74 may be a single member that extends through out the length of the first member 64 and the second member 66 of the spar structure 62. The second bush 1b may be inserted inside the aperture 76,78 and around the locking pin 74 by drilling a hole with a slightly additional diameter than the diameter of the aperture 76, 78 defined in the first part 64 and the second part 66 of the spar structure 62. The second bush 1b may further be inserted inside the hole with the slightly larger diameter and the length of the second bush may be same as the length of the first part 64 and the second part 66 of the spar structure. Further second bush 1b may be configured to not include any flanges or may include a removable flange. In an embodiment, the flange may be provided on one side of the bushings 1. In an embodiment, the second bush 1b may also be inserted inside the aperture 76, 78 and around the locking pin 74 by press fitting or by any other method known in the art. Since, the second bush 1b that is configured inside the aperture 76, 78 is a single member without any flanges, the second bush 1b may be easily assembled inside the aperture 76, 78 and the complexity for assembling or disassembling the locking pin 74 is considerably reduced. Further, configuring the second bush 1b which is single member extending through out the length of the first part 64 and the second part 66 reduces the cost during servicing. Since, the usage of multiple bushings 1 along the centeral region is avoided by using a second bush 1b which is a single member, the assembly of locking pin 74 and configuring the spar structure 62 becomes economical.

In an embodiment, the above mentioned configurations of the primary restraining mechanism 7 and the secondary restraining mechanism 9 may either be used individually while configuring the locking pin 74 or may be used in any combination together thereof. The restraining retention cap 7a, the second threading connection 7b, the threaded pin 9a, retaining ring 9b and the splined pin 9c may either be used individually while configuring the locking pin 74 or may be used in any combination together thereof.

The invention is not limited to the embodiments described herein and may be modified or adapted without departing from the scope of the present invention.

### LIST OF REFERENCE NUMERALS

1 bushings
1a first bush
1b second bush
1c third bush
2 wind turbine
4 tower
5 first threading connection
6 nacelle
7 primary restraining mechanism
7a retention cap
7b second threading connection
8 hub
9 secondary restraining mechanism
9a threaded pin
9b retention ring
9c splined pin
10 blade
14 blade tip
15 retention pin
16 blade root
18 leading edge
20 trailing edge
30 root region
32 transition region
34 airfoil region
36 pressure side shell part
38 suction side shell part
40 shoulder
41 spar cap
42 fibre layers
43 sandwich core material
45 spar cap
46 fibre layers
47 sandwich core material
50 first shear web
51 core member
52 skin layers
55 second shear web
56 sandwich core material of second shear web
57 skin layers of second shear web
60 filler ropes
62 spar structure
64 first part
65 end surface of first part
66 second part
67 spar member
68 first blade segment
69 cutting plane
70 second blade segment
74 locking pin
76, 78 aperture
80 access opening
81 threaded cavity
82 fastener

1. A mechanism for restraining movement of a locking pin 74, the mechanism comprising:
a plurality of bushings 1, wherein at least one of the plurality of bushings is provided in an aperture 76 and on either ends of the locking pin 74;
at least one primary restraining mechanism 7 configured in the at least one bushing 1 at one end of the locking pin 74, wherein the primary restraining mechanism 7 is fixedly connected to the at least one bushing 1 and is configured to restrain at least one of sliding and rotary movement of the locking pin 74;

2. A mechanism as claimed in claim 1, comprising a secondary restraining mechanism 9 configured to be accommodated in a cavity defined in the locking pin 74, wherein the secondary restraining mechanism 9 is removably coupled to the locking pin 74 through at least one of the bushing 1 and restrains the rotary movement of the locking pin 74.

3. A mechanism as claimed in claim 1, wherein the primary restraining mechanism 7 is at least one of a retention cap 7a and a threaded joint 7b.

4. A mechanism as claimed in claim 2, wherein the secondary restraining mechanism 9 is at least one of an anti-rotational pin 9a, 9c and a retention ring.

5. A mechanism according to claim 3, wherein the retention cap 7a is connected to at least one of the bushing 1 and the locking pin 74 by at least one of a first threading connection 5 and a retention pin 15.

6. A mechanism according to claim 1, wherein the at least one bushing 1 provided in the aperture extends along the length of the aperture 76.

7. A mechanism according to claim 1, wherein the at least one bushing 1 is provided on either ends of the aperture 76 defined in the spar structure 62.

8. A mechanism according to claim 1, wherein at least one of the plurality of bushings 1 provided at a top end (a) of the locking pin 74 and a bottom end (c) of the locking pin 74 are connectable to the locking pin 74 by a second threading connection 7b.

9. A mechanism according to claim 1, comprising a retaining ring 9b mounted over the retention cap 7a, wherein the retaining ring 9b is configured to receive and hold the locking pin 74.

10. A mechanism according to claim 1, wherein the cavity is defined with internal threads or a keyway to receive the anti-rotational pin 9 and the anti-rotational pin 9 is at least one of a splined pin 9c or a threaded pin 9b.

11. A wind turbine blade 10 having a profiled contour including a leading edge and a trailing edge with a chord having a chord length extending therebetween, the wind turbine blade extending in a spanwise direction between a root end and a tip end, wherein the blade 10 comprises:
a first blade segment 68 connected to a second blade segment 70 by a spar structure 62;
the spar structure 62 including a first part 64 housed in the first blade segment 68 and a second part 67 housed in the second blade segment 70, wherein the first part 64 of the spar structure 62 is defined with a first aperture 76 and the second part 67 of the spar structure 62 is defined with a second aperture 78;
a locking pin 74 provided in the aperture 76, 78 for connecting the first part 64 and the second part 67 of the spar structure 62 and connecting the first blade segment 68 to the second blade segment 70; and a mechanism for restraining movement of the locking pin 74, the mechanism comprising:
a plurality of bushings 1, at least one of the plurality of bushings is provided in each of the aperture 76 defined in the spar structure 74 and on either ends of the locking pin 74;
at least one primary restraining mechanism 7 provided in the at least one bushing provided at one end of the locking pin 74, wherein the primary restraining mechanism 7 is fixedly connected to at least one of the bushing 1 and is configured to receive the locking pin 74 to restrain at least one of sliding and rotary movement of the locking pin 74.

12. A wind turbine blade 10 according to claim 11, wherein the locking mechanism further comprising a secondary restraining mechanism 9 configured to be accommodated in a cavity defined in the locking pin 74, wherein the secondary restraining mechanism 9 is removably coupled to the locking pin 74 through the bushing 1.

13. A mechanism as claimed in claim 11, wherein the primary restraining mechanism 7 is at least one of a retention cap 7a and a threaded joint 7b.

14. A mechanism as claimed in claim 11, wherein the secondary mechanism 9 is at least one of an anti-rotational pin 9a, 9c, wherein the anti-rotational pin 9a, 9c is configured to restrain at least one of sliding and rotary movement of the locking pin 74.

15. A wind turbine blade 10 according to claim 11, wherein the retention cap 7a is connected to at least one of the bushings 1 and the locking pin 74 by at least one of first threading connection 5 and a retention pin 15,

16. A wind turbine blade 10 according to claim 11, wherein the at least one bushing provided in the aperture 76, 78 extends along the length of the aperture.

17. A wind turbine blade 10 according to claim 11, wherein the at least one of the plurality of bushings 1 provided at a top end (a) of the locking pin 74 and a bottom end (c) of the locking pin 74 are connectable to the locking pin 74 by second threading connection 7b.

18. A wind turbine blade 10 according to claim 11, comprising a retaining ring 9b mounted over the retention cap 7a, wherein the retaining ring 9b is configured to receive and hold the locking pin 74.

19. A wind turbine blade 10 according to claim 11, wherein the cavity is defined with internal threads or a keyway to receive the anti-rotational pin 9 and the anti-rotational pin 9 is at least one of a splined pin 9c or a threaded pin 9a.

20. A method of assembling a wind turbine blade 10 having a profiled contour including a leading edge and a trailing edge with a chord having a chord length extending therebetween, the wind turbine blade 10 extending in a spanwise direction between a root end and a tip end, the method comprises:
connecting a first blade segment 68 with a second blade segment 70 by a spar structure 62, the spar structure 62 comprising a first part 64 housed in the first blade segment 68 and a second part 67 housed in the second blade segment 70;
aligning a first aperture 76 defined in the first part 64 with a second aperture 78 defined in the second part 67;
inserting a locking pin 74 in the first aperture 76 and the second aperture 78 of the first part 64 and the second part 67 and connecting the first blade segment 68 with the second blade segment 70 of the wind turbine blade 10;
providing a plurality of bushings 1 in the first and the second aperture 76, 78 of the spar structure 62 for housing the locking pin 74;
providing a primary restraining mechanism 7 configured in the at least one bushing 1 at one end of the locking pin 74, wherein the primary restraining mechanism 7 is fixedly connected to the at least one bushing 1 and is configured to restrain at least one of sliding and rotary movement of the locking pin 74;
providing a secondary restraining mechanism 9 configured to be accommodated in a cavity defined in the locking pin 74, wherein the secondary restraining mechanism 9 is removably coupled to the locking pin 74 through the bushing 1 and restrains the rotary movement of the locking pin 74.
